(19) United States
(12) Patent Application Publication
(10) Pub. No.: US 2013/0225026 A1
(43) Pub. Date: Aug. 29, 2013

(54) Flexible Mirror Surface

(71) Applicant: Phil Gerard Langhorst, Crestwood, MO (US)

(72) Inventor: Phil Gerard Langhorst, Crestwood, MO (US)

(21) Appl. No.: 13/775,138

(22) Filed: Feb. 23, 2013

Related U.S. Application Data
(60) Provisional application No. 61/602,747, filed on Feb. 24, 2012.

(51) Int. Cl. B32B 7/12; B32B 5/02

(52) U.S. Cl. CPC B32B 7/12; B32B 5/022
USPC 442/394; 428/221

(57) ABSTRACT

A light reflective film with structural support. The structural support is a layer of adhesive applied to a reflective film, a polyester film attached to the applied adhesive layer, a second adhesive layer applied to the other side of the polyester film, and a fiber layer applied to the second layer of adhesive. A UV light blocker may be sprayed onto the fiber layer. Such reflective surface being ideal for use in tension member solar collection systems.

### CROSS-REFERENCE TO RELATED APPLICATIONS

Not Applicable.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to reflective surface and, more particularly to a mirrored surface with structural support for preventing creep when under long-term tension.

2. Related Art

There are many different reflective film products that are commercially available from various manufacturers. For example, one manufacturer is ReflecTech, Inc., and another is The 3M Company. An example of a reflective film product that is commercially available may consist of five layers: an acrylic layer for protection from the physical environment, a silver layer for reflectance, a copper layer for strength, an adhesive layer to assist in applying the film to a solid object (these four layers collectively referred to as “reflective film”), and a polyester film for peeling off and the preventing of premature contact with an unintended solid object. In use, the polyester film is peeled off, and the reflective film is applied to a solid object such as sheet metal. Other commercially available reflective film products may use a different number of layers, and may use a metal other than silver for reflectance (such aluminum) sandwiched between various polymer layers, which may or may not include UV light inhibiting or UV light blocking layers. Common to all reflective film products is that the product is in the form of a sheet roll that is glued to a solid such as sheet metal or glass.

### SUMMARY OF THE INVENTION

The present invention is a reflective film with structural support. The structural support is a layer of adhesive applied to a reflective film, a polymer film attached to the applied adhesive layer, a second adhesive layer applied to the other side of the polymer film, and a fiber layer applied to the second layer of adhesive. A UV light blocker may be sprayed onto the fiber layer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates an elevated view of the prior art.

FIG. 2 illustrates an elevated view of the present invention.

### DETAILED DESCRIPTION OF THE PREFERRED EMBODIMENTS

The following description of the preferred embodiment(s) is merely exemplary in nature and is in no way intended to limit the invention, its application, or uses.

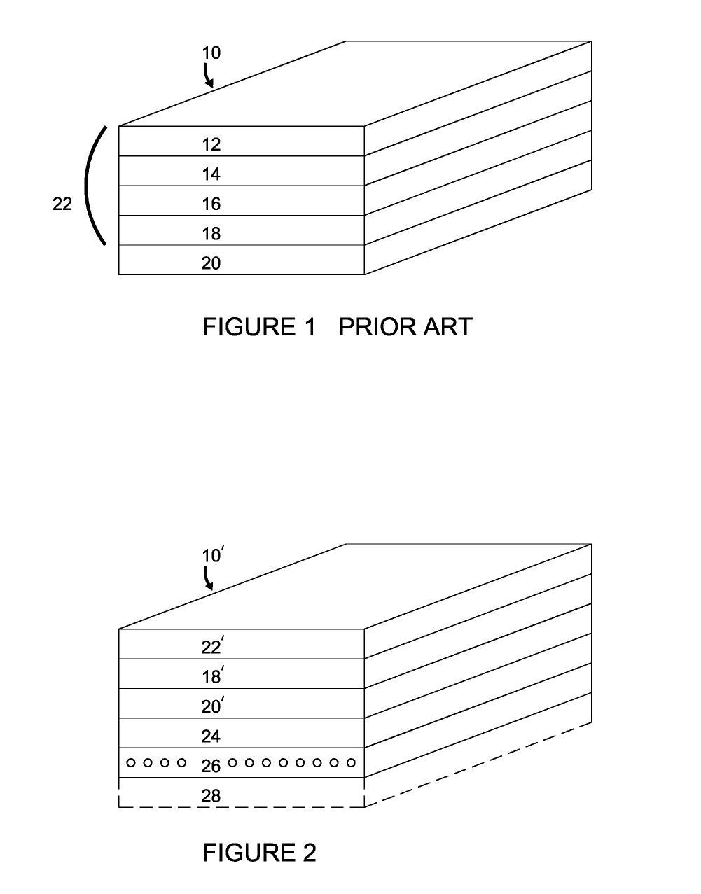

FIG. 1 illustrates an elevated view of a prior art product. Reflective product, shown generally at 10, comprises an external acrylic layer 12, a reflective layer 14, a foundation layer 16, an adhesive layer 18, and a polymer layer 20. Layers 12, 14, 16, and 18 are collectively referred to hereinafter as “reflective film 22”. It should be understood that there are many different ways to layer materials to produce a reflective film. The layering shown in FIG. 1 is simply one example of layering, but a reflective film may be produced using a different number of layers, a different material selection for each layer, a different ordering of layers, and a different number of layers. Generally, a “reflective film” is a flexible sheet with multiple layers where one side of the sheet has a high reflectance, and does not have the rigidity to maintain a planar surface when extended an unsupported distance of twelve inches.

Polymer layer 20 is used to protect the adhesive layer 18 before the intended use of reflective film 22. In use, polymer layer 20 is peeled away from reflective film 22. Then, reflective film 22 is applied to a solid object such as sheet metal, by placing newly exposed adhesive layer 18 in physical contact with the solid object.

FIG. 2 illustrates an elevated view of the reflective product or reflective device 10′ of the present invention. In the present invention, reflective product 10′ comprises a reflective film layer 22′, an adhesive layer 18′, a polymer layer 20′, a second adhesive layer 24, and a fiber layer 26. Reflective film layer 22′ is a flexible sheet with multiple layers where one side of the sheet has a high reflectance, and does not have the rigidity to maintain a planar surface when extended an unsupported distance of twelve inches.

The adhesive layer 18′ is different from the adhesive layer 18 of the prior art. Adhesive layer 18′ permanently bonds reflective film layer 22′ to polymer layer 20′ such that polymer layer 20′ cannot be peeled or separated from reflective film layer 22′. It is important that polymer layer 20′ remain bonded. The difference between polymer layer 20 (FIG. 1) and polymer layer 20′ (FIG. 2) is that the polymer of polymer layer 20 is selected to separate easily from or detach easily from reflective film 22, whereas the polymer of polymer layer 20′ is selected prevent separation from or detachment from (to enhance fixation with) reflective film 22′. When reflective product 10′ of the present invention is placed under tension, polymer layer 20′ prevents the texture of fiber layer 26 from visibly pressing through reflective film layer 22′, and therefore allows reflective film layer 22′ to remain a smooth surface. Adhesive layer 18 is preferably an adhesive that retains adhesion under tension, and that will stretch as the other layers of reflective product 10′ stretch when placed under tension.

It is possible that if the commercial product is initially used, in an alternative embodiment of the present invention, another adhesive layer 18′ may be applied over the existing adhesive layer 18. In such a situation, reflective product 10′ of the alternative embodiment of the present invention has two adhesive layers, 18 and 18′ instead of a single adhesive layer 18′ as shown in FIG. 2.

Fiber layer 26 is any fiber material that resists creep (permanent stretch) under long-term tension. Therefore, cloths made from materials such as cotton, fiberglass, or nylon are suitable. In addition, newer engineered materials such as fiber-reinforced composites (E-glass, glass, carbon fiber, Kevlar carbon, basalt fiber, etc.) are also suitable. At present, the preference is for cloths made from long fibers that run parallel to the direction of the intended applied tension. As a result, the most preferred embodiment at present is a unidirectional fiberglass cloth. A unidirectional fiberglass cloth allows some elastic stretch, but resists creep. This allows the resulting reflective product 10′ to hold a tension stretch without significant permanent lengthening. As shown in FIG. 2, the ends of various filaments comprising fiber layer 26 are shown.

Further shown in FIG. 2 is an optional UV coating layer 26. This UV coating layer 26 may be sprayed onto fiber layer 26. UV coating layer 26 prevents or blocks UV light from penetrating through fiber layer 26 and reaching polyester layer 20. Polyester material is known to break down over time when exposed to UV light. UV coating layer 26 is preferably composed of any substance that inhibits the penetration of UV light, such as zinc oxide.

The resulting reflective product 10′ of the present invention is flexible, but strong enough to be placed under tension. In use, the reflective product 10′ of the present invention may be used in tension about a structural frame, and still retain film-like flexibility for wrapping or bending about a structural frame, without need of any continuous sheet metal support. The prior art reflective product 10 shown in FIG. 1 cannot be placed in tension about a structural frame without attachment to a further surface such as sheet metal.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A light reflective device comprising:
a light reflective film;
a second layer comprising a first adhesive;
a third layer comprising polymer;
a fourth layer comprising a third adhesive; and
a fifth layer comprising a fiber cloth.

2. A light reflective device according to claim 1, wherein said reflective film comprises a flexible sheet composed of multiple layers where one side of the sheet has a high reflectance, and wherein said reflective film does not have the rigidity to maintain a planar surface when extended an unsupported distance of twelve inches.

3. A light reflective device according to claim 1, wherein said reflective film has a high light reflectance of greater than 90%,

4. A light reflective device according to claim 1, further comprising a sixth layer comprising a UV light inhibitor.

5. A light reflective device according to claim 1, where said fiber cloth comprises unidirectional fiber formed from at least one of the following materials: cotton, fiberglass, nylon, E-glass, glass, carbon fiber, Kevlar carbon, and basalt fiber; and such that said fiber cloth allows stretching under tension, but resists creep.

6. A light reflective device according to claim 1, wherein said fiber cloth is infused with resin.
